(19) United States
(12) Patent Application Publication
(10) Pub. No.: US 2024/0391128 A1
(43) Pub. Date: Nov. 28, 2024

(54) Circular Saw Guiding Device, Method of Customization, and Method Of Use

(71) Applicant: Thomas L. Juranek, Harrisburg, SD (US)

(72) Inventor: Thomas L. Juranek, Harrisburg, SD (US)

(21) Appl. No.: 18/201,146

(22) Filed: May 23, 2023

(51) Int. Cl. B27B 9/04; B27B 27/02

(52) U.S. Cl. CPC B27B 9/04; B27B 27/02

(57) ABSTRACT

A circular saw guiding device for facilitating cutting perpendicularly to a selected edge of a substrate includes a guide plate that is rectangular. A first rail is attached to a lower face in parallel with a first edge of the guide plate. The first rail can be abutted to the selected edge with the guide plate positioned atop the substrate. First and second fences are attached to an upper face of the guide plate and extend in parallel between the first edge and a second edge of the guide plate, thereby defining first, second, and medial sections of the guide plate. The first and second sections have widths equivalent those of narrow and wide sections of a circular saw's base plate, respectively. The first and second fences can be abutted to either an outer edge or an outer limit of the narrow and wide sections, respectively, to guide a cut.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to saw guides and more particularly pertains to a new saw guide for facilitating cutting perpendicularly to a selected edge of a substrate. The present invention discloses a saw guide comprising a guide plate that can be cut to match the widths of narrow and wide sections base plates of a variety of circular saws.

### (2) Description of Related Art Including Information Disclosed Under 37 CFR 1.97 and 1.98

The prior art does not teach a saw guide comprising a guide plate comprised of first and second sections that have widths complementary to the widths of narrow and wide sections of a base plate of a circular saw to facilitate cutting from left or right handed positions relative to the saw.

### BRIEF SUMMARY OF THE INVENTION

An embodiment of the disclosure meets the needs presented above by generally comprising a guide plate, which is rectangular. A first rail is attached to a lower face of the guide plate and extends between a first side and a second side of the guide plate proximate to and parallel with a first edge of the guide plate. The first rail is configured to be abutted to a selected edge of a substrate with the guide plate positioned atop the substrate. A first fence and a second fence are attached to an upper face of the guide plate and extend in parallel between the first edge and a second edge of the guide plate defining a first section, a second section and a medial section of the guide plate. The first section and the second section extend along a first side and a second side of the guide plate, respectively, and have widths equivalent to those of narrow and wide sections of a base plate of a circular saw, respectively. The first section and the second section are configured for selective positioning of the narrow section and the wide section of the base plate, respectively, with an outer edge of the narrow section and an outer limit the wide section abutting the first fence and the second fence, respectively. A user is positioned to actuate the circular saw to selectively cut the substrate perpendicularly to the selected edge.

Another embodiment of the disclosure includes method of customizing a circular saw guiding device. Steps of the method include positioning a narrow section of a base plate of a circular saw upon a first section of a guide plate, abutting an outer edge of the narrow section to a first fence, and passing a blade of the circular saw through the first section for cutting the first section to match a width of the narrow section. Additional steps of the method entail positioning a wide section of the base plate upon a second section of guide plate, abutting an outer limit of the wide section to the second fence, and passing the blade through the second section for cutting the second section to match a width of the wide section.

Yet another embodiment of the disclosure includes method of cutting a substrate perpendicularly to a selected edge. Steps of the method include positioning a guide plate atop a substrate so that a first rail attached to a lower face of the guide plate abuts a selected edge of the substrate, positioning a first edge of the guide plate on the substrate at a desired location for making a cut, positioning a narrow section of a base plate of a circular saw upon a first section of the guide plate, abutting an outer edge of the narrow section to a first fence attached to an upper face of the guide plate, and passing a blade of the circular saw through the substrate for cutting the substrate perpendicularly to the selected edge.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a circular saw guiding device according to an embodiment of the disclosure.

FIG. 2 is a bottom isometric perspective view of an embodiment of the disclosure.

FIG. 3 is a side view of an embodiment of the disclosure.

FIG. 4 is an end view of an embodiment of the disclosure.

FIG. 5 is an in-use view of an embodiment of the disclosure.

FIG. 6 is an in-use view of an embodiment of the disclosure.

FIG. 7 is an in-use view of an embodiment of the disclosure.

FIG. 8 is an in-use view of an embodiment of the disclosure.

FIG. 9 is an in-use view of an embodiment of the disclosure.

FIG. 10 is an in-use view of an embodiment of the disclosure.

FIG. 11 is a flow diagram for a method of customizing an embodiment of the disclosure.

FIG. 12 is a flow diagram for a cutting method utilizing an embodiment of the disclosure.

### DETAILED DESCRIPTION OF THE INVENTION

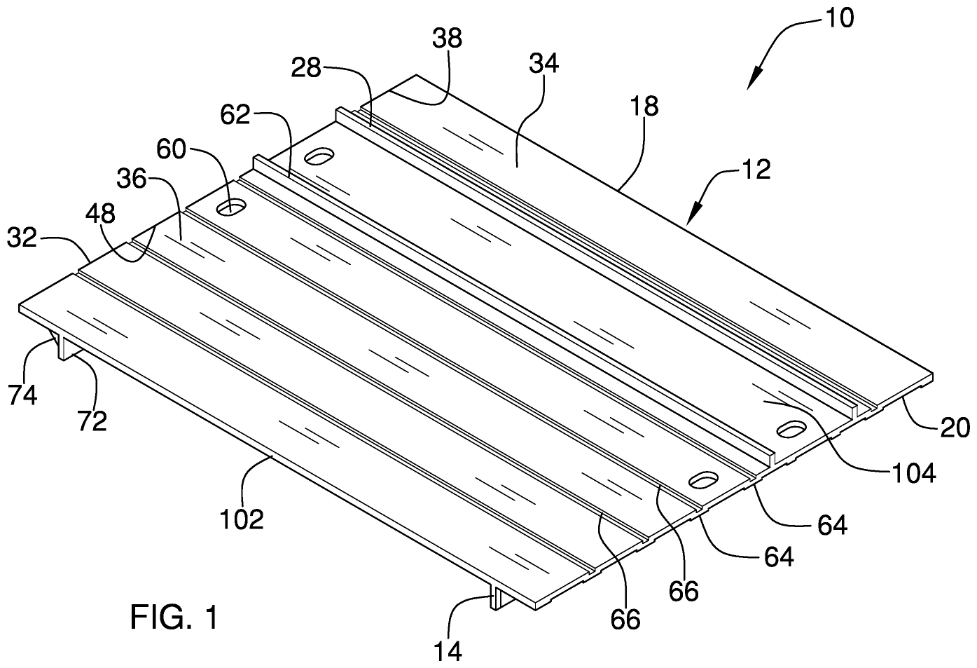

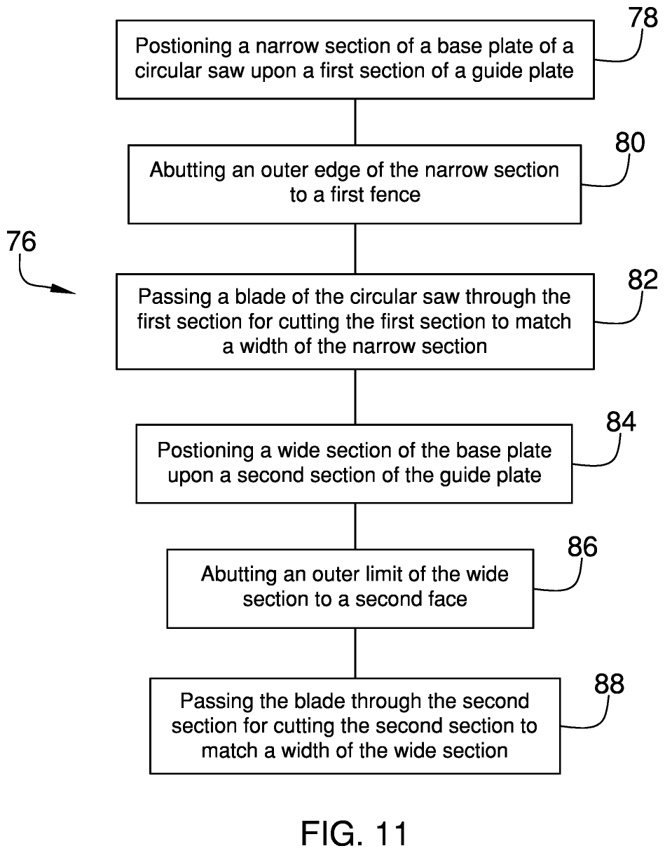

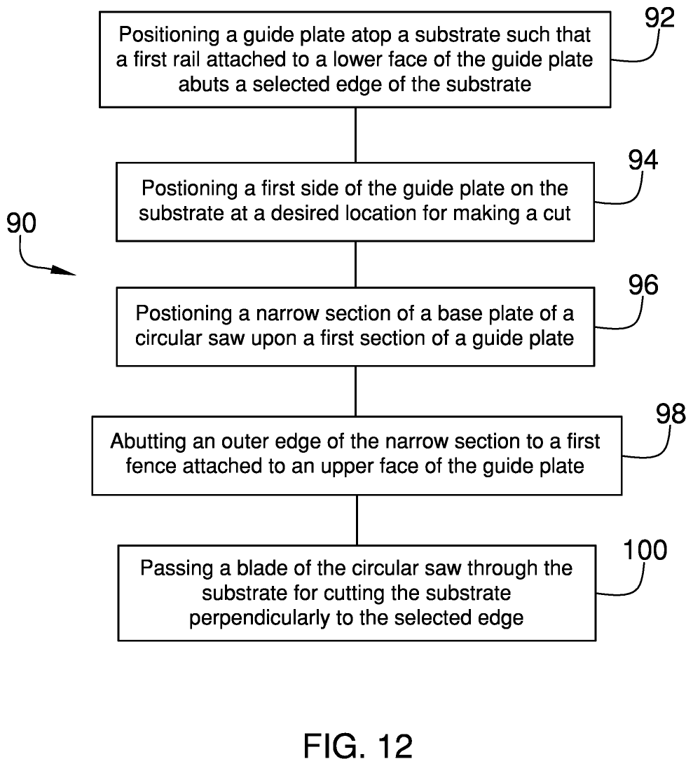

With reference now to the drawings, and in particular to FIGS. 1 through 12 thereof, a new saw guide embodying the principles and concepts of an embodiment of the disclosure and generally designated by the reference numeral 10 will be described.

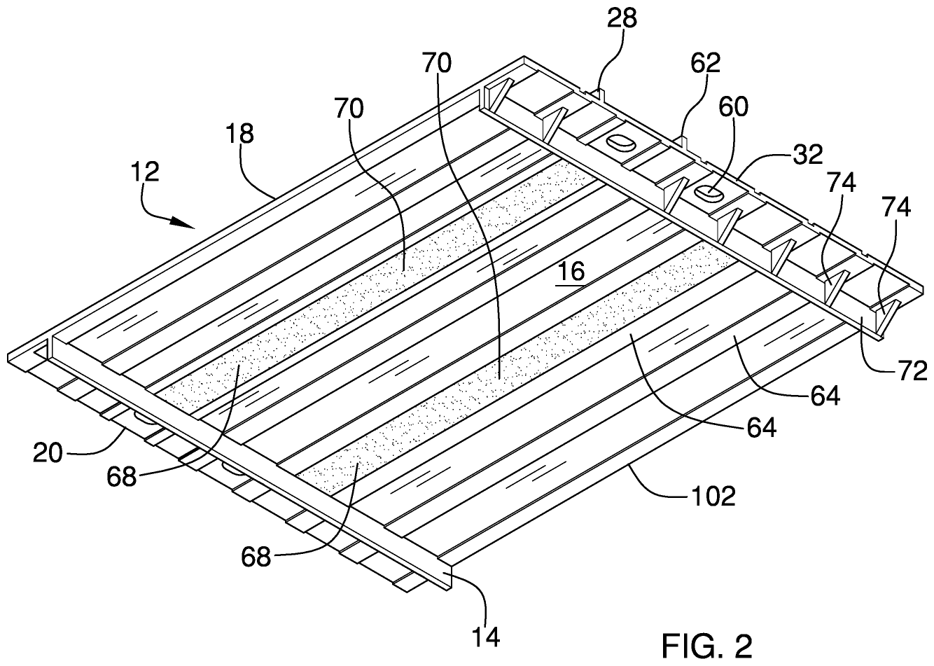

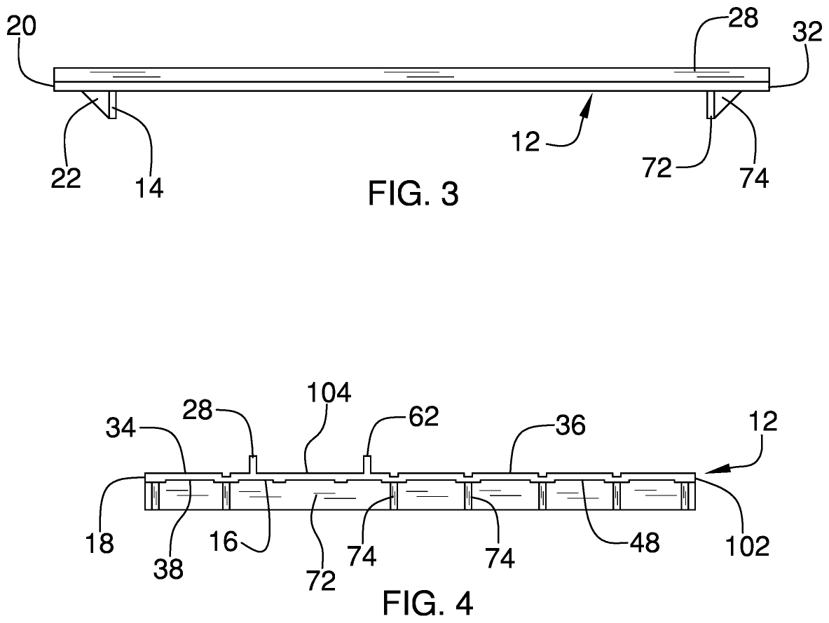

As best illustrated in FIGS. 1 through 12, the circular saw guiding device 10 generally comprises a guide plate 12, which is rectangular. A first rail 14 is attached to a lower face 16 of the guide plate 12 and extends between a first side 18 and a second side 102 of the guide plate 12 proximate to and parallel with a first edge 20 of the guide plate 12. The circular saw guiding device 10 also may comprise a plurality of gussets 22. Each gusset 22 is attached to and extends between the first rail 14 and the guide plate 12, as is shown in FIGS. 2 and 3. The gussets 22 extend from the first rail 14 toward the first edge 20 of the guide plate 12 and stabilize the first rail 14 relative to the guide plate 12. The first rail 14 is configured to be abutted to a selected edge 24 of a substrate 26 with the guide plate 12 positioned atop the substrate 26.

A first fence 28 and a second fence 62 are attached to an upper face 30 of the guide plate 12 and extend in parallel between the first edge 20 and a second edge 32 of the guide plate 12. The first fence 28 is parallel to the first side 18 of the guide plate 12 and defines a first section 34 of the guide plate 12 having a width 38 equivalent to a width 40 of a narrow section 42 of a base plate 44 of a circular saw 46. The second section 36 and the second side 102 of the guide plate 12 define a second section 36 of the guide plate 12 having a width 48 equivalent to a width 50 of wide section 52 of the base plate 44. The first fence 28 and the second fence 62 also define a medial section 104 of the guide plate 12.

The first section 34 and the second section 36 are configured for selective positioning of the narrow section 42 and the wide section 52 of the base plate 44, respectively, with an outer edge 54 of the narrow section 42 and an outer limit 56 of the wide section 52 abutting the first fence 28 and the second fence 62, respectively. A user is positioned to actuate the circular saw 46 to selectively cut the substrate 26 perpendicularly to the selected edge 24.

Circular saw 46 in the context of this specification should be interpreted to mean any handheld motorized saw that is equipped with a base plate 44 through which a blade 58 extends. The circular saw guiding device 10 offers several advantages, as will be apparent to those skilled in the art of saw guides. It can be readily repositioned, thereby enabling the user to make numerous cuts in rapid succession and with a high level of reproducibility. The ready repositioning of the circular saw guiding device 10 also enables rapid switching between left handed cuts and right handed cuts. The medial section 104 and the first section 34 provide ample space for a user to position their hand for stabilizing the guide plate 12 while cutting with the wide section 52 of the base plate 44 of the circular saw 46 positioned on the second section 36 of the guide plate 12. Additionally, the guide plate 12 is positioned between the base plate 44 and the substrate 26, thereby preventing any marring of the substrate 26 as the cuts are made. A hole 60 is positioned in the guide plate 12 and is configured for selective insertion of a hanging element (not shown), such as a hook, nail, or the like, to stow the circular saw guiding device 10 when its use is not required.

As is shown in FIG. 2, a plurality of slats 64 is attached to the lower face 16 of the guide plate 12, with each slat 64 extending between the first edge 20 and the second edge 32. A plurality of channels 66 extends into the upper face 30 of the guide plate 12, with each channel 66 extending between the first edge 20 and the second edge 32 in alignment with a respective slat 64. The slats 64 and the channels 66 bias the guide plate 12 to a planar configuration. The first edge 20 and the second edge 32 of the guide plate 12 are separated by from 4.0 to 100.0 cm. The first edge 20 and the second edge 32 may be separated by from 30.0 to 50.0 cm.

As is shown in FIG. 2, a plurality of grips 68 is attached to the lower face 16 of the guide plate 12. The plurality of grips 68 is configured to limit slippage of the guide plate 12 upon the substrate 26. Each grip 68 comprises a strip 70 that extends from proximate to the first edge 20 to proximate to the second edge 32. The strip 70 comprises resiliently compressible elastomer and thus is configured to frictionally engage the substrate 26. As is shown in FIG. 2, two strips 70 are attached to the lower face 16 of the guide plate 12, but the present invention anticipates any number of strips 70 being attached to the lower face 16. The strips 70 also may be attached such that they extend between the first side 18 and the second side 102 of the guide plate 12.

The circular saw guiding device 10 also may comprise a second rail 72, which is attached to the lower face 16 of the guide plate 12 and which extends between the first side 18 and the second side 102 of the guide plate 12 proximate to and parallel with the second edge 32. The second rail 72, like the first rail 14, is configured to be abutted to a selected edge 24 of a substrate 26 with the guide plate 12 positioned atop the substrate 26. The second rail 72 provides flexibility to the user when cutting substrates 26 that will fit between the first rail 14 and the second rail 72 in that the user can cut the substrate 26 from either side. The user also can rotate the guide plate 12 180° to position the second section 36 of the guide plate 12 to receive the wide section 52 of the base plate 44, which is a preferred approach to making cuts.

Each brace 74 of a plurality of braces 74 is attached to and extends between the second rail 72 and the guide plate 12, as is shown in FIG. 3. The braces 74 extend from the second rail 72 toward the second edge 32 of the guide plate 12 and stabilize the second rail 72 relative to the guide plate 12.

In one configuration, the guide plate 12, the first fence 28, the second fence 62, and the first rail 14 comprise plastic, wood, or the like, and are configured to be cut by the blade 58 of the circular saw 46. Also in this configuration, the first section 34 and the second section 36 of the guide plate 12 are dimensionally wider than the narrow section 42 and the wide section 52 of a base plate 44, respectively. Thus configured, the circular saw guiding device 10 is readily customizable to a variety of circular saws 46 wherein the narrow section 42 and the wide section 52 of a base plate 44 have a variety of widths (40 and 50, respectively). The first section 34 is configured to have positioned upon it the narrow section 42 of the base plate 44, with the outer edge 54 of the narrow section 42 abutting the first fence 28. The user then is positioned to pass the blade 58 of the circular saw 46 through the first section 34 to cut the first section 34 to match the width 40 of the narrow section 42. Similarly, the second section 36 is configured to have positioned upon it the wide section 52 of the base plate 44, with the outer limit 56 of the wide section 52 abutting the second fence 62. The user then is positioned to pass the blade 58 of the circular saw 46 through the second section 36 to cut the second section 36 to match the width 50 of the wide section 52.

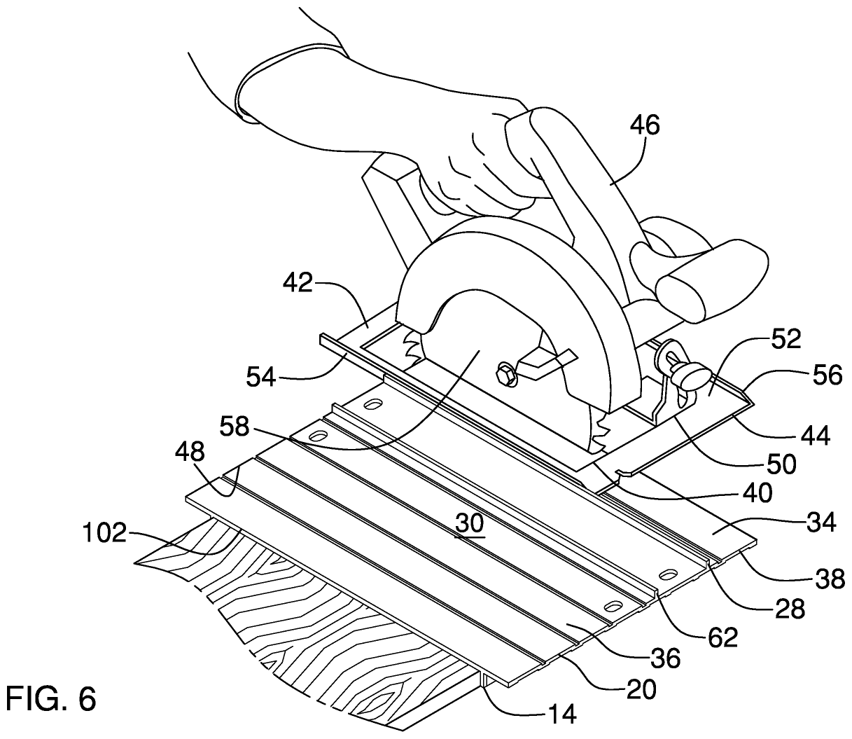

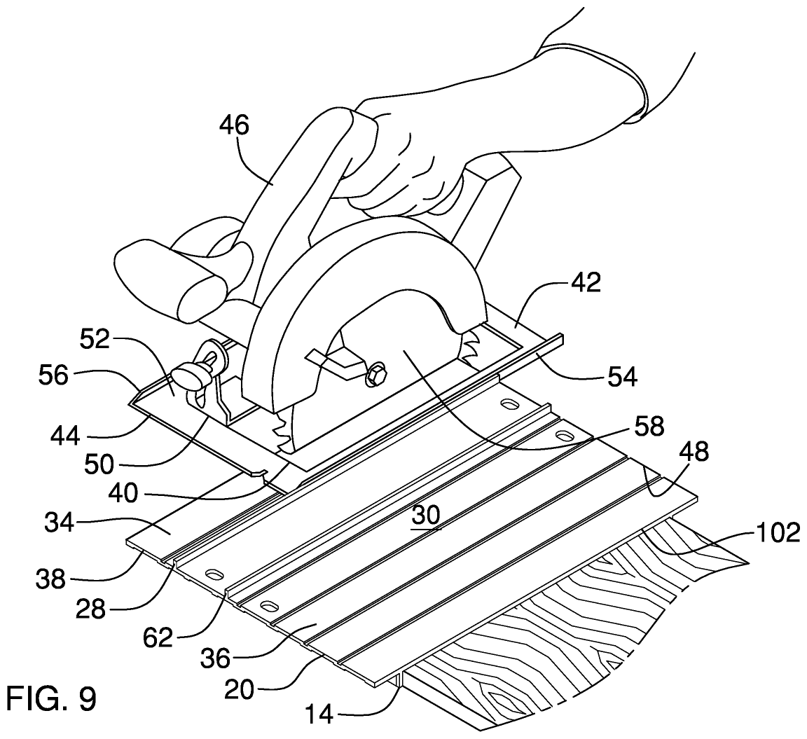

The present invention anticipates a method of customizing a circular saw guiding device 76. A first step 78 of the customization method 76 is positioning a narrow section 42 of a base plate 44 of a circular saw 46 upon a first section 34 of a guide plate 12, as is shown in FIGS. 6 and 9 for circular saws 46 which are configured a right handed user and a left handed user, respectively. The first section 34 is dimensionally wider than the narrow section 42. A second step 80 of the customization method 76 is abutting an outer edge 54 of the narrow section 42 to a first fence 28 that is attached to an upper face 30 of the guide plate 12. A third step 82 of the customization method 76 is passing a blade 58 of the circular saw 46 through the first section 34 to cut the first section 34 to match a width 40 of the narrow section 42.

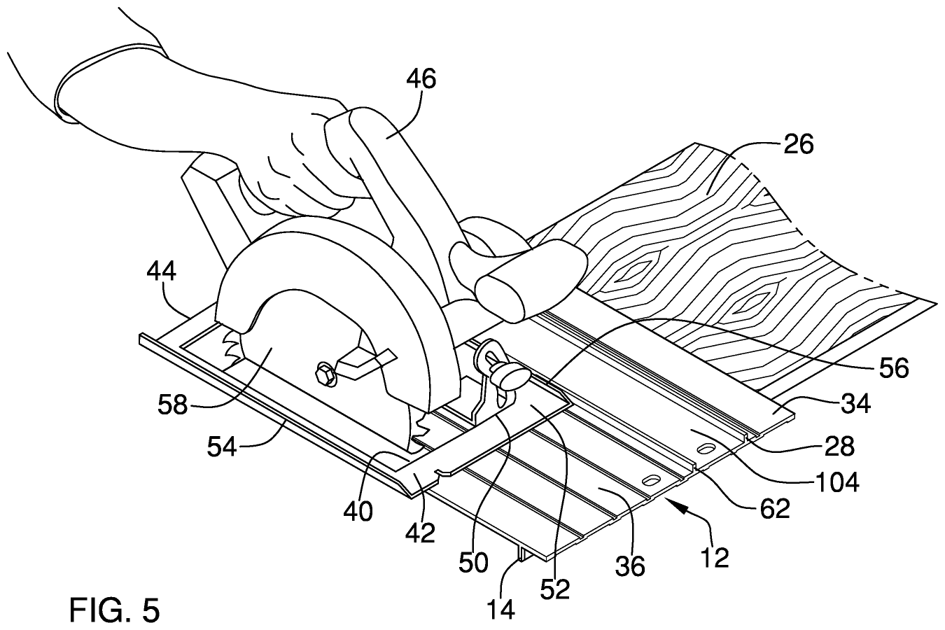

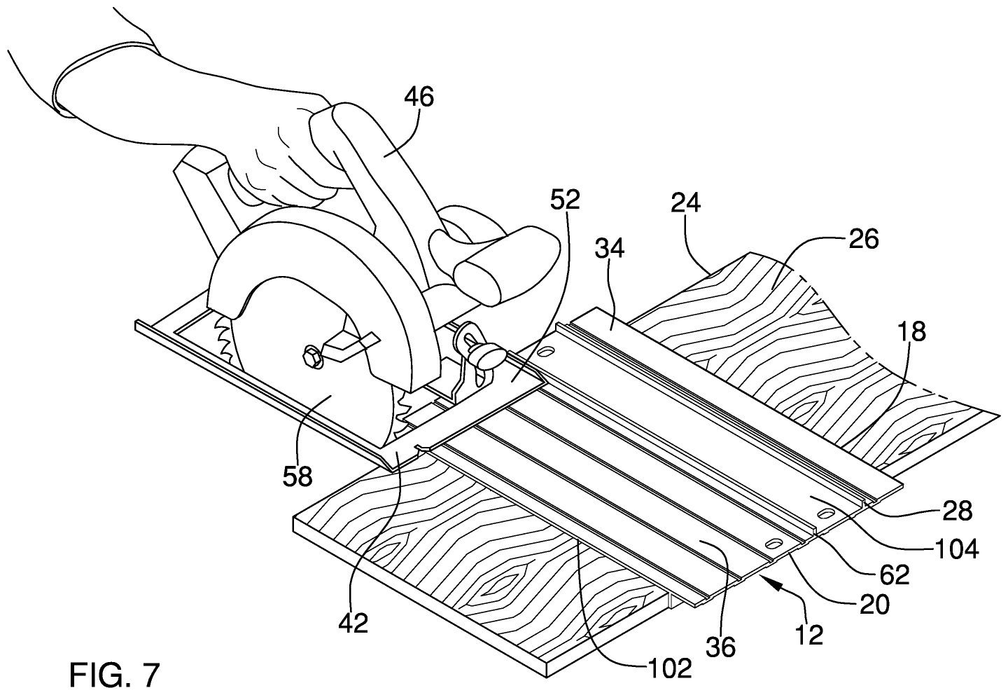

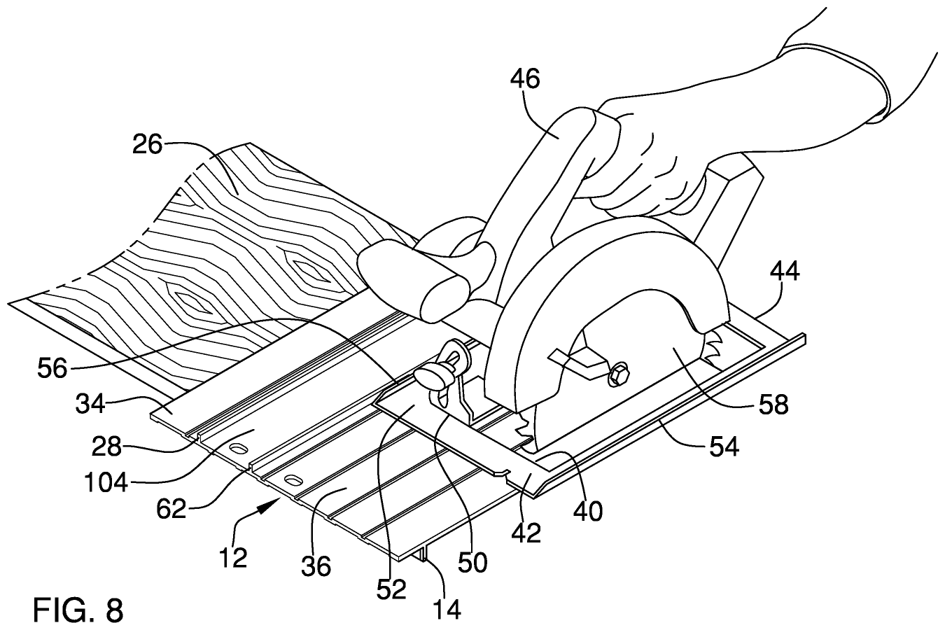

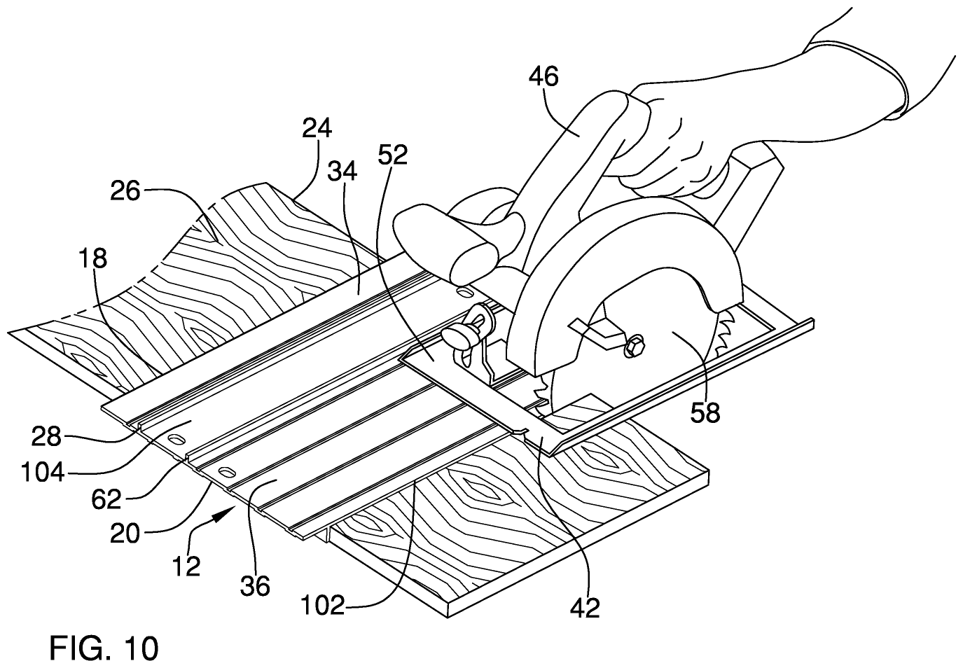

A fourth step 84 of the customization method 76 is positioning a wide section 52 of the base plate 44 upon a second section 36 of guide plate 12, as is shown in FIGS. 5 and 8 for circular saws 46 which are configured a right handed user and a left handed user. The second section 36 is dimensionally wider than the wide section 52. A fifth step 86 of the customization method 76 is abutting an outer limit 56 of the wide section 52 to a second fence 62. A sixth step 88 of the customization method 76 is passing the blade 58 through the second section 36 to cut the second section 36 to match a width 50 of the wide section 52. As is shown in FIG. 7 and FIG. 10, the circular saw guiding device 10 has been customized for use with a right handed circular saw and a left handed circular saw, respectively.

In use, the circular saw guiding device 10 enables a method of cutting a substrate perpendicularly to a selected edge 90. The cutting method 88 comprises a first step 92 of positioning a guide plate 12 atop a substrate 26 such that a first rail 14 that is attached to a lower face 16 of the guide plate 12 abuts the selected edge 24 of the substrate 26. A second step 94 of the cutting method 88 is positioning a first side 18 of the guide plate 12 on the substrate 26 at a desired location for making a cut. A third step 96 of the cutting method 88 is positioning a narrow section 42 of a base plate 44 of a circular saw 46 upon a first section 34 of the guide plate 12. A fourth step 98 of the cutting method 88 is abutting an outer edge 54 of the narrow section 42 to a first fence 28 that is attached to an upper face 30 of the guide plate 12. A fifth step 100 of the cutting method 88 is passing a blade 58 of the circular saw 46 through the substrate 26 to cut the substrate 26 perpendicularly to the selected edge 24.

Alternatively, depending on positioning of the substrate 26 and access to the selected edge 24, the cutting method 88 may entail positioning a second side 102 of the guide plate 12 on the substrate 26 at a desired location for making a cut, positioning of a wide section 52 of the base plate 44 upon a second section 36 of the guide plate 12, and abutting an outer limit 56 of the wide section 52 to the second fence 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A circular saw guiding device comprising:
a guide plate, the guide plate being rectangular;
a first rail attached to a lower face of the guide plate and extending between a first side and a second side of the guide plate proximate to and parallel with a first edge of the guide plate, wherein the first rail is configured for abutting a selected edge of a substrate with the guide plate positioned atop the substrate; and
a first fence attached to an upper face of the guide plate and extending perpendicularly between the first edge and a second edge of the guide plate proximate to and parallel to the first side of the guide plate defining a first section of the guide plate, the first section having a width equivalent to a width of a narrow section of a base plate of a circular saw;
a second fence attached to the upper face of the guide plate and extending in parallel with the first fence defining a medial section between the second fence and the first fence, the second fence and the second side of the guide plate defining a second section of the guide plate, the second section having a width equivalent to a width of wide section of the base plate, wherein the first section and the second section are configured for selective positioning of the narrow section and the wide section of the base plate, respectively, with an outer edge of the narrow section and an outer limit the wide section abutting the first fence and the second fence, respectively, positioning a user for actuating the circular saw for selectively cutting the substrate perpendicularly to the selected edge

2. The circular saw guiding device of claim 1, wherein the guide plate, the first fence, the second fence and the first rail comprise plastic or wood, wherein the guide plate, the first fence, the second fence, and the first rail are configured for being cut by the blade of the circular saw.

3. The circular saw guiding device of claim 2, wherein:
the guide plate, the first fence, the second fence, and the first rail comprise plastic;
a plurality of slats attached to the lower face of the guide plate, each slat of the plurality of slats extending between the first edge and the second edge; and
a plurality of channels extending into the upper face of the guide plate, each channel of the plurality of channels extending between the first edge and the second edge and being aligned with a respective slat of the plurality of slats, such that the plurality of slats and the plurality of channels bias the guide plate to a planar configuration.

4. The circular saw guiding device of claim 1, wherein the first edge and the second edge are separated by from 4.0 to 100.0 cm.

5. The circular saw guiding device of claim 4, wherein the first edge and the second edge are separated by from 30.0 to 50.0 cm.

6. The circular saw guiding device of claim 1, further including a plurality of grips attached to the lower face of the guide plate, wherein the plurality of grips is configured for limiting slippage of the guide plate upon the substrate.

7. The circular saw guiding device of claim 6, wherein each grip of the plurality of grips comprises a strip extending from proximate to the first edge to proximate to the second edge, the strip comprising resiliently compressible elastomer, wherein the strip is configured for frictionally engaging the substrate.

8. The circular saw guiding device of claim 1, further including a plurality of gussets, each gusset of the plurality of gussets being attached to and extending between the first rail and the guide plate, the gussets of the plurality of gussets extending from the first rail toward the first edge of the guide plate, such that the first rail is stabilized relative to the guide plate.

9. The circular saw guiding device of claim 1, further including a second rail attached to the lower face of the guide plate and extending between the first side and the second side of the guide plate proximate to and parallel with the second edge, wherein the second rail is configured for abutting a selected edge of a substrate with the guide plate positioned atop the substrate.

10. The circular saw guiding device of claim 9, further including a plurality of braces, each brace of the plurality of braces being attached to and extending between the second rail and the guide plate, the braces of the plurality of braces extending from the second rail toward the second edge of the guide plate, such that the second rail is stabilized relative to the guide plate.

11. The circular saw guiding device of claim 2, wherein:
the first section and the second section of the guide plate are dimensionally wider than the narrow section and the wide section of a base plate, respectively;
wherein the first section is configured for positioning of the narrow section of the base plate, such that an outer edge of the narrow section abuts the first fence, positioning a user for passing a blade of the circular saw through the first section for cutting the first section to match the width of the narrow section; and
wherein the second section is configured for positioning of the wide section of the base plate, such that an outer limit of the wide section abuts the second fence, positioning a user for passing the blade of the circular saw through the second section for cutting the second section to match the width of the wide section.

12. The circular saw guiding device of claim 1, further including a hole positioned in the guide plate, wherein the hole is configured for selective insertion of a hanging element for stowing the guide plate.

13. A method of customizing a circular saw guiding device comprising the steps of:
positioning a narrow section of a base plate of a circular saw upon a first section of a guide plate, the first section being dimensionally wider than the narrow section;
abutting an outer edge of the narrow section to a first fence attached to an upper face of the guide plate;
passing a blade of the circular saw through the first section for cutting the first section to match a width of the narrow section;
positioning a wide section of the base plate upon a second section of the guide plate, the second section being dimensionally wider than the wide section;
abutting an outer limit of the wide section to a second fence; and
passing the blade through the second section for cutting the second section to match a width of the wide section.

14. A method of cutting a substrate perpendicularly to a selected edge comprising the steps of:
positioning a guide plate atop a substrate such that a first rail attached to a lower face of the guide plate abuts a selected edge of the substrate;
positioning a first side of the guide plate on the substrate at a desired location for making a cut;
positioning a narrow section of a base plate of a circular saw upon a first section of the guide plate;
abutting an outer edge of the narrow section to a first fence attached to an upper face of the guide plate; and
passing a blade of the circular saw through the substrate for cutting the substrate perpendicularly to the selected edge.

15. The method of claim 15, wherein:
a second side of the guide plate is positioned on the substrate at the desired location for making the cut;
a wide section of the base plate is positioned upon a second section of the guide plate; and
an outer limit of the wide section is abutted to a second fence.
